(19) United States
(12) Patent Application Publication
(10) Pub. No.: US 2008/0099662 A1
(43) Pub. Date: May 1, 2008

(54) Method for adjusting an object detection apparatus

(75) Inventors: Michael J. Musiel, Sheboygan, WI (US); Daniel R. Todd, Sheboygan, WI (US); Thomas P. Alberti, Port Washington, WI (US); Bryan D. DeMaster, Grafton, WI (US)

Correspondence Address: WELLS ST. JOHN P.S., 601 W. FIRST AVENUE, SUITE 1300, SPOKANE, WA, 99201, US

(73) Assignee: Muth Global Visions, LLC

(21) Appl. No.: 11/591,130

(22) Filed: Oct. 31, 2006

(51) Int. Cl. G01J 1/32

(52) U.S. Cl. 250/205

(57) ABSTRACT

A method for adjusting an object detection apparatus is disclosed and which includes the steps of providing an image intensifier tube having an electroluminescent screen, and which produces a screen current output when the image intensifier tube processes electromagnetic radiation; measuring the screen current output produced by the electroluminescent screen; providing an emitter of electromagnetic radiation which is electrically coupled with a source of electricity, and which, when periodically energized, produces an electromagnetic radiation output; and adjusting the period of time which the emitter of electromagnetic radiation is energized based upon the screen current output which is measured at the electroluminescent screen.

### TECHNICAL FIELD

The present invention relates to an object detection apparatus, and more specifically to a method for adjusting an object detection apparatus which includes an image intensifier tube having a shutter electrode or assembly, and which is useful in viewing objects in environments having, on the one hand, low ambient light, and on the other hand, other conditions which prohibit the timely and effective imaging of the objects. The present methodology provides a means for producing a visibly discernable image of objects under varying lighting conditions.

### BACKGROUND OF THE INVENTION

The prior art is replete with numerous examples of prior art night vision, and other imaging devices such as night vision scopes, laser range finders, and other similar devices which have been used in various civilian and military applications. In U.S. Pat. Nos. 6,700,123 and 7,015,642, an object detection apparatus, and an image intensifier tube which is useful in an object detection apparatus have been disclosed. In U.S. Pat. No. 7,015,642, an image intensifier tube was described and which included a main body having a shutter electrode and which had a first operational condition (activated) which permits electromagnetic radiation forming an optical image to be processed by the image intensifier tube, and a second operational condition (deactivated) which substantially prevents the electromagnetic radiation forming the optical image from being processed by the image intensifier tube. The shutter electrode is placed in the first open condition for a predetermined duration of time. The duration of time is adjustable by means of a controller which rapidly cycles between the first and second operational conditions to produce a visibly discernable image on a electroluminescent screen. This prior art image intensifier tube may be cycled between the opened (activated) and closed (deactivated) conditions during a time period as little as 5 nanoseconds, and perhaps faster, and further produces a visibly discernable image on the image intensifier tube electroluminescent screen having an optical resolution of greater than about 50 lines per millimeter. The aforementioned image intensifier tube continues to produce a visibly discernable image while the image intensifier tube is being simultaneously exposed to multiple sources of visibly discernable light. Other second and third generation image intensifier tube designs which utilize microchannel plates and other design schemes could also be employed in the present invention. For example, a prior art microchannel plate design could be utilized in place of the earlier described shutter electrode.

The object detection apparatus as revealed in these prior art U.S. patents included a controller which was electrically coupled to an emitter of electromagnetic radiation, and a receiver of electromagnetic radiation (a light or image intensifier tube) which is operable to receive reflected electromagnetic radiation and provide an electrical output. Further, a control circuit was provided which was influenced by the speed of operation of an overland vehicle and which adjusted the location of an area of interest which was viewed by an operator based, at least in part, upon the speed of the overland vehicle.

Many additional prior art references have recently been disclosed and which provide teachings for various night vision and other methodology useful in imaging objects of interest under difficult lighting conditions. Such U.S. patents include U.S. Pat. Nos. 6,412,950; 6,429,429; 6,730,913; 6,795,237; 6,897,465; 6,967,569; and 7,079,974. The teachings of these and the other prior art references discussed above are incorporated by reference herein.

While the prior art references, noted above, have worked with varying degrees of success, the inventors of the present application have endeavored to develop methodology which optimally adjusts the object detection apparatus as described in earlier U.S. Pat. Nos. 6,700,123, 7,015,642, and other second and third generation image intensifier tubes so as to produce a resulting visibly discernable image having improved characteristics and usefulness when that same object detection apparatus and resulting arrangement is deployed on an overland vehicle of conventional design.

A method for adjusting an object detection apparatus of the present invention is the subject matter of the present application.

### SUMMARY OF THE INVENTION

A first aspect of the present invention relates to a method for adjusting an object detection apparatus which includes providing an image intensifier tube having an electroluminescent screen, and which produces a screen current output when the image intensifier tube processes electromagnetic radiation; measuring the screen current output produced by the electroluminescent screen; providing an emitter of electromagnetic radiation which is electrically coupled with a source of electricity, and which, when periodically energized, produces an electromagnetic radiation output; and adjusting the period of time which the emitter of electromagnetic radiation is energized based upon the screen current output which is measured at the electroluminescent screen.

Another aspect of the present invention relates to a method for adjusting an object detection apparatus which includes the steps of providing an image intensifier tube having an electroluminescent screen, and which further produces a screen current when the image intensifier tube processes electromagnetic radiation; providing a shutter assembly operably coupled to the image intensifier tube and which when activated and then deactivated causes the electroluminescent screen to produce a light output which comprises an image frame having an associated first screen current; providing an emitter of electromagnetic radiation which is operably coupled to the image intensifier tube and the shutter assembly, and which, when energized, produces electromagnetic radiation which is directed towards an area of interest; measuring the first screen current associated with a first image frame when the emitter of electromagnetic radiation is deenergized, and the shutter assembly is activated; after the step of measuring the first screen current associated with a first image frame, energizing the emitter of electromagnetic radiation to direct electromagnetic radiation to the area of interest; timing the energizing of the emitter of electromagnetic radiation; activating and deactivating the shutter assembly at a predetermined time after the energizing of the emitter of electromagnetic radiation to capture electromagnetic radiation reflected from the area of interest, and to produce a second image frame which is associated with a second screen current; comparing the screen currents associated with the first and second image frames to determine if the second screen current associated with the second image frame has a greater magnitude relative to the first screen current associated with the first image frame; and adjusting the duration of time that the emitter of electromagnetic radiation is energized, and the shutter assembly is activated, and then deactivated based upon the comparison of the screen currents associated with the first and second image frames.

Still another aspect of the present invention relates to a method for adjusting an object detection apparatus which includes the steps of providing an image intensifier tube having an electroluminescent screen and which produces a screen current and a light output when the image intensifier tube processes electromagnetic radiation; providing a shutter assembly which is operably coupled to the image intensifier tube and which, when selectively energized, can be placed in a first, activated condition which allows light or electromagnetic radiation to be processed by the image intensifier tube, and a second, deactivated condition, which substantially prevents light or electromagnetic radiation from being processed by the image intensifier tube; providing an emitter of electromagnetic radiation which, when selectively energized, produces pulses of electromagnetic radiation which are directed towards, and reflected from, an object of interest and which are then received and processed by the image intensifier tube; providing and positioning an imaging device in light output receiving relation relative to the electroluminescent screen; providing a controller which is controllably coupled with each of the image intensifier tube, shutter assembly and emitter of light, and wherein the controller continually energizes the image intensifier tube, selectively energizes the emitter of electromagnetic radiation, and further activates and deactivates the shutter assembly in a predetermined manner so as to cause the electroluminescent screen to produce a light output which can be converted into a visibly discernible electronic image of the object of interest by the imaging device; providing an image signal processor which is operably coupled with each of the controller, and the imaging device, and wherein the image signal processor receives the visibly discernible electronic image produced by the imaging device, and produces a visibly discernible composite image output representative of the object of interest; determining a screen current threshold produced by the electroluminescent screen when the electroluminescent screen is producing an undiscernable image of the object of interest; selectively energizing the emitter of electromagnetic radiation, continually energizing the image intensifier tube, and activating and deactivating the shutter assembly so as to cause the electroluminescent screen to produce multiple image frames each having an associated screen current; comparing the respective screen currents of the multiple image frames against the predetermined screen current threshold to determine if the screen currents associated with the respective multiple image frames exceed the predetermined screen current threshold; and decreasing the duration that the shutter assembly is activated and then deactivated, so as to cause the electroluminescent screen to produce a light output which can be substantially continually converted into a visibly discernible electronic image of the object of interest by the imaging device.

Yet a further aspect of the present invention relates to a method for adjusting an object detection apparatus of the present invention, and which includes the steps of (a) providing an image intensifier tube having an electroluminescent screen, and which processes electromagnetic radiation, and which produces a light output from the electroluminescent screen and a screen current associated with the light output; (b) providing an emitter of electromagnetic radiation which, when selectively energized, produces pulses of electromagnetic radiation which are directed at, and reflected from an object of interest; (c) providing a shutter assembly which is operably coupled to the image intensifier tube, and which when selectively activated and deactivated permits the image intensifier tube to receive, and then process, the pulses of electromagnetic radiation which are reflected from the object of interest, and other electromagnetic radiation which is generated by the object of interest; (d) providing a controller which is operably coupled to the image intensifier tube, emitter of electromagnetic radiation and shutter assembly and which continually energizes the image intensifier tube, selectively energizes the emitter of electromagnetic radiation and which further activates and deactivates the shutter assembly; (e) providing an imaging device which is located adjacent to the electroluminescent screen and which receives the light output of the electroluminescent screen and which converts the light output into a visibly discernable electronic image of the object of interest; (f) determining a threshold screen current produced by the electroluminescent screen and which is associated with the production of an undiscernable electronic image by the imaging device; (g) energizing the image intensifier tube and activating and deactivating the shutter assembly, and then measuring a first screen current produced by the electroluminescent screen; (h) after step (g) energizing the image intensifier tube, and the emitter of electromagnetic radiation which produces a pulse of electromagnetic radiation which is directed to, and reflected from, the object of interest, and then activating and deactivating the shutter assembly at a predetermined time, and measuring a second screen current produced by the electroluminescent screen; (i) comparing the first and second screen currents to each other and to the predetermined threshold screen current; (j) adjusting the duration of time that the emitter of electromagnetic radiation is energized, and the shutter assembly is activated and then deactivated based upon the comparison of the screen currents; and (k) periodically repeating steps g-j so that a visually discernable electronic image of the object of interest is produced by the imaging device.

Still another aspect of the present invention relates to a method for adjusting an object detection apparatus which includes providing an image intensifier tube having an electroluminescent screen, and which produces a screen current output when the image intensifier tube processes electromagnetic radiation; measuring the screen current output produced by the electroluminescent screen; providing an emitter of electromagnetic radiation which is electrically coupled with a source of electricity, and which, when periodically energized, produces an electromagnetic radiation output; and adjusting the intensity of the electromagnetic radiation output of the emitter of electromagnetic radiation based, at least in part, upon the screen current output which is measured at the electroluminescent screen.

These and other aspects of the present invention will become more apparent hereinafter.

### BRIEF DESCRIPTION OF THE DRAWINGS

Preferred embodiments of the invention are described below with reference to the following accompanying drawings.

FIG. 1 is a greatly simplified, schematic diagram of an object detection apparatus which achieves the methodology of the present invention.

FIG. 2 is a greatly simplified, schematic view of an overland vehicle which incorporates features of the present invention.

FIG. 3 is a greatly simplified, schematic view of an object detection apparatus as employed on an overland vehicle to view areas of interest in advance of the path of movement of the overland vehicle.

FIG. 4 is a flow chart of a first logic which implements features of the present invention.

FIG. 5 is a flow chart of a second logic which implements features of the present invention.

FIG. 6 is a flow chart of a third logic which implements features of the present invention.

FIG. 7A is a flow chart of a fourth logic which implements features of the present invention.

FIG. 7B is a continuation of the fourth logic flow chart as seen in FIG. 7.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

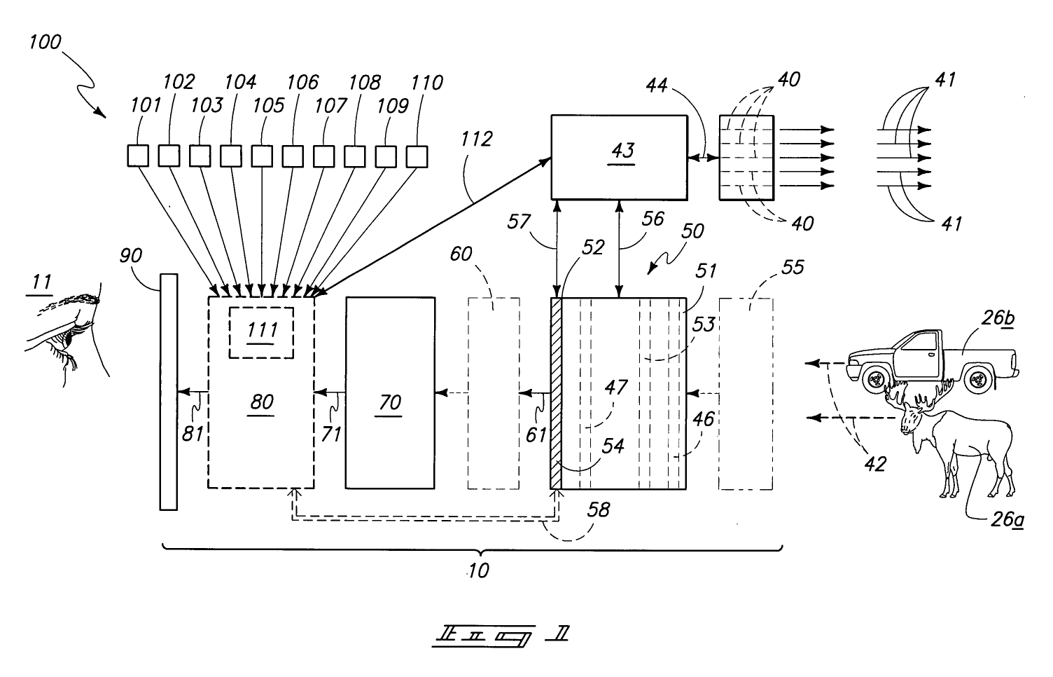

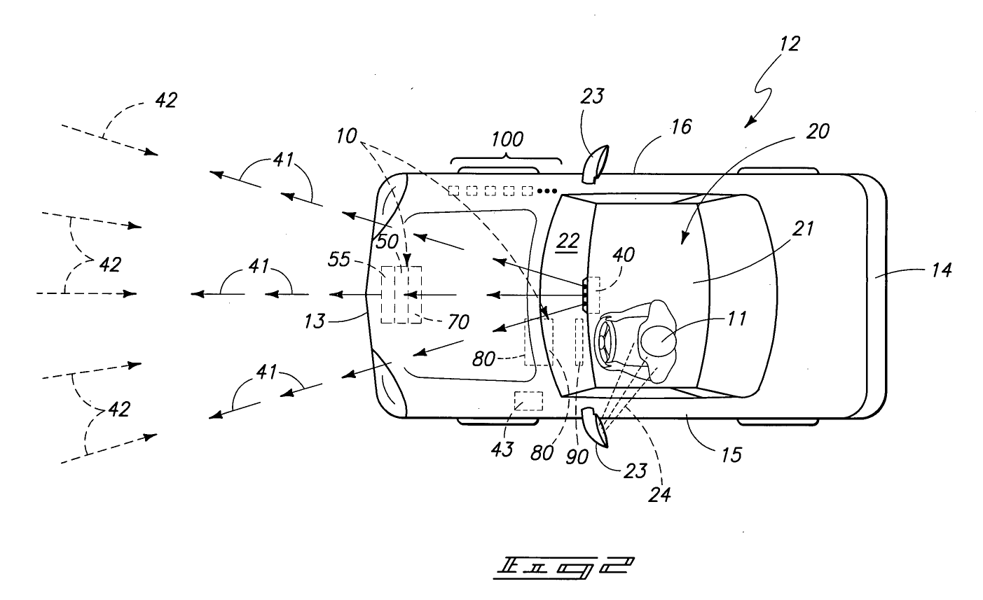

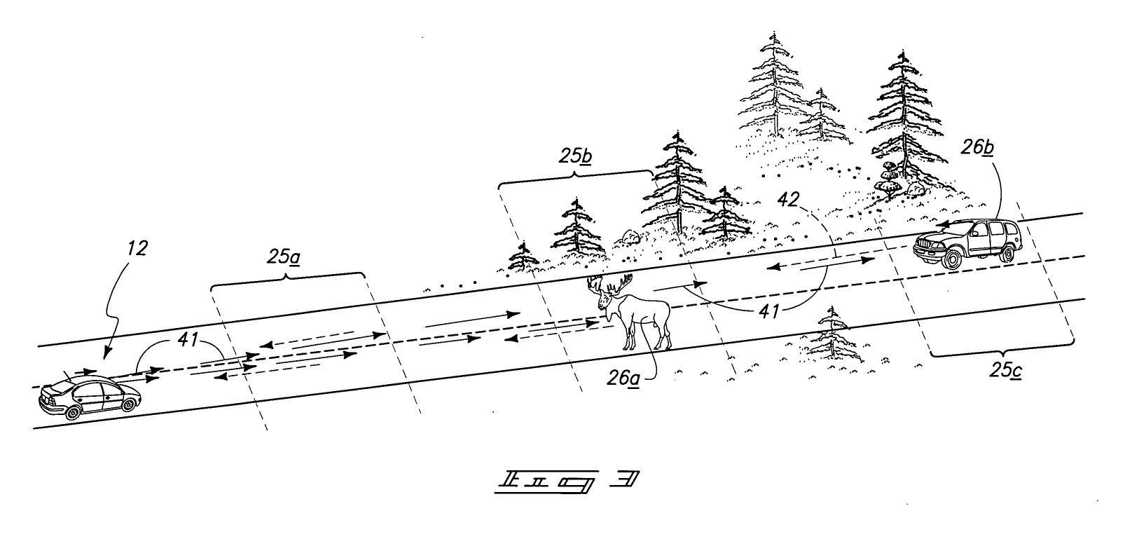

A greatly simplified view of an object detection apparatus 10 which implements the methodology of the present invention is shown in FIG. 1. Referring now to FIGS. 2 and 3, the object detection apparatus 10 of the present invention may be utilized by an observer 11 who is traveling in an overland vehicle 12 of substantially conventional design. The overland vehicle includes a first end 13 and an opposite second end 14. Still further, the overland vehicle has a driver's side 15, and an opposite passenger's side 16. The overland vehicle includes a passenger's compartment 20 in which the observer 11 travels. Still further, the passenger's compartment may be enclosed by a roof 21, and a windshield 22. Additionally, the overland vehicle 12 may be equipped with conventional side view mirrors which are positioned on the driver's and passenger's sides 15, 16, or further, it may be equipped with signaling assemblies 23. The signaling assemblies may be of conventional design utilizing the technology as disclosed in such U.S. patents as U.S. Pat. Nos. 5,014,167; 5,207,492; 5,361,190; 5,499,169; 6,005,724; 6,257,746; 7,104,676; and 7,008,091, for example. If equipped with signaling assemblies, such as seen in these patents, these devices would be rendered operable to transmit a visual signal which could be seen by the observer or operator 11 when they are seated in the passenger compartment 20. This visual signal could be employed as a warning light to alert the operator to view a display device which is also installed in the passenger compartment 20. The display device will be discussed in greater detail hereinafter. Referring now to FIG. 3, the object detection apparatus 10, when installed on an overland vehicle 12, is operable to image areas of interest, here identified as 25a, 25b and 25c which are positioned forward of, and along the intended path of travel of the overland vehicle 12. The object detection apparatus 10 as will be described hereinafter is operable to provide visibly discernable images of objects 26, here indicated as a moose 26a, or another overland vehicle 26b which are located within the areas of interest 25a, b and c and which may be moving relative to the overland vehicle 12. This movement could be directly in the path of travel of the overland vehicle, or it could be along the side of the depicted roadway, but in a direction which would cause it to pass into the path of the overland vehicle. The areas of interest 25a, b and c, represent individual depths of field relative to the observer 11.

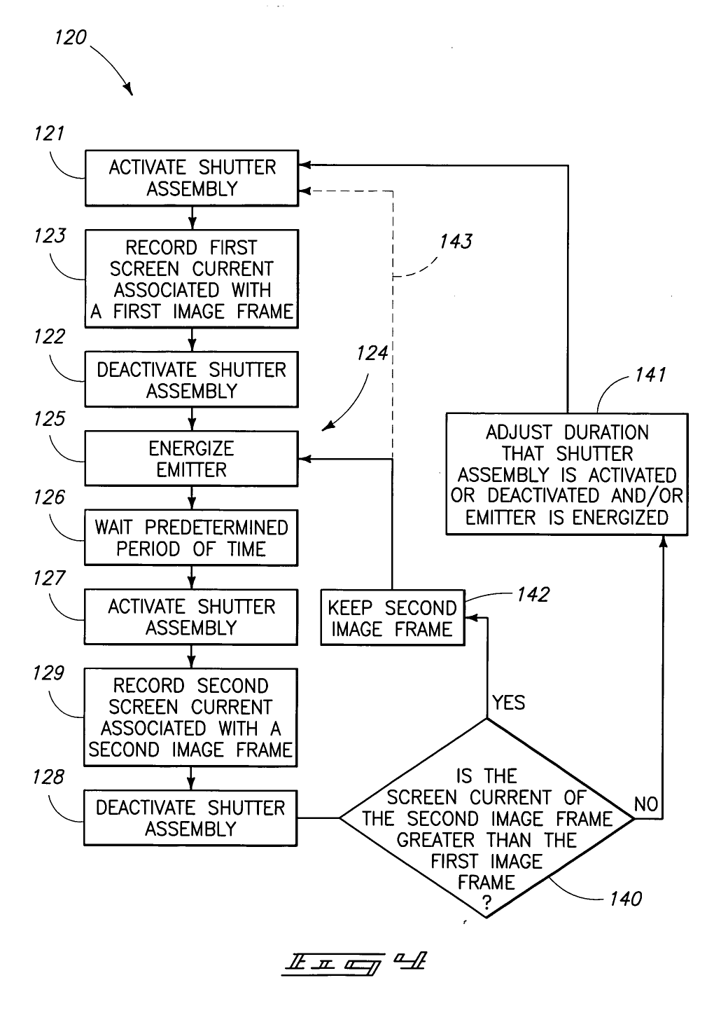

As best appreciated by a study of FIGS. 1 and 2, the object detection apparatus 10 of the present invention may include one, or a plurality of emitters of electromagnetic radiation 40 which are seen, in this form of the invention, mounted adjacent to the roof 21 of the overland vehicle 12 and positioned within a cut-out region of the windshield 22 so as to be oriented in a forward facing direction; along the intended path of travel of the overland vehicle 12; and unobstructed by the windshield 22. In another possible form of the invention, the plurality of emitters 40 could be mounted on one or more of the signaling assemblies 23 which are mounted on the sides 15 and 16 of the overland vehicle (not shown) or other locations such as in the headlamps or other locations where they are oriented in an unobstructed, forward facing direction. The plurality of emitters 40, in one form of the invention, generate infrared radiation with either a single or a multiplicity of light emitting diodes or laser diodes which are eye-safe. In another possible form of the invention, the emitters may emit visibly discernable light; or still further, a combination of visibly discernable and invisible electromagnetic radiation. In yet another possible form of the invention, the plurality of emitters 40 may emit a pulsed beam of emitted electromagnetic radiation 41. In this form, the pulsed beam may have a particular signature or pulsed beam pattern such that a reflected beam 42 of the same pulsed electromagnetic radiation 41 coming from objects 26a and 26b, and within the area of interest 25a, b and c may be easily detected or discriminated by the object detection apparatus 10. As noted above, the plurality of emitters 40 are electrically coupled to, and controlled by a control electronics package or arrangement, hereinafter generally referred to as an intelligent controller 43, which is mounted on the overland vehicle 12, and which controls the selective energizing of the respective plurality of emitters 40, and other functions so as to achieve the benefits of the present invention. The controller 43 implements, at least in part, logic which is best understood by reference to FIGS. 4-7, respectively. As should be understood, the plurality of emitters 40, and controller 43 are energized by a source of electricity (not shown) which is derived from the overland vehicle 12. The controller 43 is controllably coupled to the emitters 40. This is generally shown by the line labeled 44.

Therefore, it should be understood that one aspect of the present invention, relates to a method for adjusting an object detection apparatus 10 and which includes the step of selectively energizing the emitter 40 so as to produce pulses of electromagnetic radiation 41 which are directed towards, and reflected from 42 an object of interest 26a or 26b so as to produce a resulting visibly discernable image as the objects of interest 26a or 26b traverse a depth of field within the areas of interest 25a, b and c, respectively.

Electrically coupled to, and controlled by the controller 43 is an image intensifier tube which is generally indicated by the numeral 50. One embodiment of the image intensifier tube is described in particular detail in U.S. Pat. Nos. 6,700,123 and 7,015,642, the teachings of which are incorporated by reference herein. An image intensifier tube having the previously described construction would have a photocathode 46 and a photoanode 47. Further discussion regarding the construction of the image intensifier tube does not appear to be warranted. As noted earlier, other second and third generation light or image intensifier tubes could be employed with equal success in carrying out the features of the present invention. In such prior art devices, a microchannel plate would be employed to process, at least in part, electromagnetic radiation within the image intensifier tube 50. As a general matter, the image intensifier tube has a first end 51, which typically encloses a photocathode 46, and an opposite second end 52. Disposed intermediate the opposite first and second ends is a shutter assembly or shutter electrode 53 which is electrically coupled to the controller 43. A photoanode 47 is located between the second end 52, and the shutter electrode. The controller is operable to selectively activate and deactivate the shutter electrode or assembly 53 so as to admit and allow the processing of a reflected beam of pulsed electromagnetic radiation (either visible or invisible) 42, and which is reflected from objects 26a and 26b which are located and moving within the areas of interest 25a, b and c, respectively. In one possible form of the invention, the image intensifier tube gain could be decreased by decreasing the voltage potential between the photoanode 47 and an enclosed microchannel plate, which functions as the shutter assembly 53. In yet another possible form of the invention, the microchannel plate, functioning as the shutter assembly 53 could be effected (activating or deactivating of same) by rapidly switching the voltage on and off between the photocathode 46 and the microchannel plate.

The controller 43 is further operable to both selectively energize either a single or a plurality of emitters 40 at a selectively adjustable frequency; in an adjustable pattern; at an adjustable time period delay; and/or at a variable output intensity, and to further activate and deactivate the shutter electrode or assembly 53 so as to facilitate the generation of consecutive image frames which thereafter may be processed in a novel manner so as to provide a visibly discernable and useful image which can be seen by the observer 11 within the passenger compartment 20 of the overland vehicle 12. Positioned on the second end 52 of the image intensifier tube 50 is an electroluminescent screen 54, as previously described, in the prior art patents first mentioned, above. In the present invention input optics 55 may be optionally provided and located in light transmitting relation relative to first end 51 of the image intensifier tube 50. The input optics utilized with the present invention may be selected from the group that includes, but is not limited to, zoom or prime lenses; fixed or variable focus lenses; fixed or variable aperture lenses; or other optics of conventional design. Typically, the input optics may include such optical assemblies as filters, and the like, and which are operable to pass certain frequencies or wavelengths of electromagnetic radiation, such as infrared light or other visible or invisible light, in an efficient fashion so it may be subsequently processed by the image intensifier tube 50. As seen in FIG. 1, the controller 43 is controllably coupled to the image intensifier tube. This is generally indicated by the line labeled 56. Further, the controller 43 is coupled in screen current sensing relation relative to the electroluminescent screen 54. This is indicated by the line labeled 57. Further, as seen in FIG. 1, the screen current output of the electroluminescent screen 54 is provided, at least in part, to an image signal processor (this is indicated by the line 58) which will be described in greater detail hereinafter.

Therefore, one aspect of the method for adjusting an object detection apparatus of the present invention 10 may include the steps of, providing an image intensifier tube 50 having an electroluminescent screen 54, and which produces a screen current output 57, 58 when the image intensifier tube 50 processes electromagnetic radiation 42; measuring the screen current output produced by the electroluminescent screen 54; providing an emitter of electromagnetic radiation 40 which is electrically coupled with a source of electricity, and which, when periodically energized, produces an electromagnetic radiation output; and adjusting the period of time, frequency, duration, pattern, time delay, and output intensity with which the emitter 40 is energized based upon the screen current output which is measured at the electroluminescent screen 54. The method for adjusting an object detection apparatus 10 includes another step of providing a shutter assembly or shutter electrode 53 which is operably coupled to the image intensifier tube 50, and which, when activated and deactivated, causes the image intensifier tube 50 to produce an image frame which is associated with a screen current output 57, 58. The method also includes another step of providing a controller 43 which is operably coupled 56 to the image intensifier tube; emitter 40; and shutter assembly 53; and which, during operation, continually energizes the image intensifier tube 50; and further selectively activates, and deactivates, the shutter electrode or assembly 53; and further selectively energizes the light emitter 40 so as to produce a pulsed beam of emitted electromagnetic radiation 41. The reflected electromagnetic radiation 42 which is received by the image intensifier tube 50 can then be subsequently processed into a visibly discernible image as will be described in greater detail below. As should be understood, the method of the present invention further includes another step of selectively adjusting the duration that the shutter assembly or electrode 53 is activated, and then deactivated, as the object of interest 26a and 26b traverses a predetermined depth of field so as to cause the object detection apparatus 10 as described to continually produce a visibly discernible image which is useful for the observer or operator 11. In the arrangement as described, and before the step of selectively adjusting the duration that the shutter assembly or electrode 53 is activated, and then deactivated, the method includes another step of predicting, in time and space, the relative movement of the object of interest 26a and 26b within the depth of field. This prediction of the relative movement of the object of interest within the depth of field is typically provided by an image signal processor based upon numerous inputs which are provided to same. Both the image signal processor and the various inputs to same will be discussed in greater detail below.

In one aspect of the invention, a method for adjusting an object detection apparatus 10 includes the steps of providing a shutter assembly or electrode 53 which is operably coupled to the controller 43, and which is selectively activated, and then deactivated, so as to cause the image intensifier tube 50 to process electromagnetic radiation 42, and further cause the electroluminescent screen 54 to produce a first image frame; measuring a screen current 57, 58 associated with the first image frame which is produced by the electroluminescent screen 54 of the image intensifier tube 50 when the shutter assembly 53 is activated, and then deactivated, and when the emitter 40 is deenergized; measuring the screen current associated with a second image frame which is provided by the electroluminescent screen 54 when the shutter assembly 53 is activated, and then deactivated, following the energizing of the emitter 40; comparing the screen current associated with the first and second image frames by means of the controller 43; and adjusting the duration of time; number of times; pattern; time delay and/or the output intensity with which the emitter 40 is energized; and the shutter assembly 53 is activated, and then deactivated, based, at least in part, upon a comparison of the screen currents associated with the first and second image frames so as to cause the electroluminescent screen 54 to produce an optical output 61 which can be converted into a resulting visibly discernible image.

Referring in particular to FIG. 1, the object detection apparatus 10 of the present invention includes, in one form of the invention, transfer optics 60 which are operable to receive the visibly discernable image, or optical output 61 which is provided by the electroluminescent screen 54, and to transfer the visibly discernable image or optical output 61 to an imaging device or camera 70. The transfer optics may include conventional lenses; fiber optic conduits or the like. The imaging device 70 may comprise a charge couple device (CCD); CMOS assembly; HDRC (High Dynamic Range Camera); or other image capture device of conventional design, and which is operable to receive the visibly discernable image or optical output 61 provided by the transfer optics 60, and convert the visibly discernable image 61 into either an analog or digital electrical signal image output 71. In one possible form of the invention, the imaging device 70 may be made integral with the second end 52 of the image intensifier tube 50.

The electrical image output 71 is provided to an image signaling processor 80. Further, the processor 80 is coupled in screen current sensing relation 58 relative to the electroluminescent screen 54. The image signal processor 80 is of conventional design, and is operable to receive the electrical image output 71; analyze the electrical image output; and convert the electrical image output into a composite electrical image output 81 which is then electrically transmitted to a display apparatus 90 which is positioned within the passenger compartment 20. When received, the display apparatus 90 converts the composite electrical image output 81 into a visibly discernable image which can then be perceived by the observer 11. For purposes of the present invention, it should be understood that the composite image output 81 may comprise one or more image frames which form the resulting visibly discernable image which is perceptible by the observer 11. Alternatively, the composite image output 81 may comprise single or multiple image frames provided by the electroluminescent screen 54, and which have been analyzed, manipulated, amended and/or otherwise changed by the image signal processor 80 so as to provide additional helpful information to the operator of the overland vehicle 12. Such manipulation or amendment of the respective image frames, and the purposes and advantages of same will be discussed in the paragraph which follows.

The image digital signal processor 80 is provided with numerous inputs from a plurality of sensors, processors, or input devices 100 which may be mounted on the overland vehicle 12. For example, the plurality of sensors 100 may include, but are not limited to, a GPS sensor 101 for providing location information regarding the overland vehicle 12; a speed sensor 102 for sensing the speed of the overland vehicle; a distance or range sensor 103 which determines the distance of the overland vehicle 12 to the objects 26a, or 26b; a shape recognition sensor 104; a size recognition sensor 105; a time sensor 106; an outside temperature sensor 107; an outside humidity sensor 108; a traction sensor 109 for determining the condition of the roadway under the overland vehicle 12; a microbolometer 110, and/or electromagnetic radiation sensor, to name but a few. The multiplicity of sensors or input devices 100 which may be located in various locations on the overland vehicle 12 or which may be made integral with or otherwise coupled in signal transmitting or receiving relation relative to the image signal processor 80, and/or controller 43 to produce outputs which are provided to a danger assessment logic 111 which may be resident within the image signal processor 80. The danger assessment logic can provide assorted warnings, and threat information to the observer or operator 11 of the overland vehicle 12 by manipulating the composite image output 81. Additionally, this same danger assessment logic could in a possible collision scenario arm or predeploy airbag restraints; activate the vehicle braking or seatbelt system; transmit information to another similarly equipped vehicle to indicate the presence of the overland vehicle; or send signals to various on-board audio devices to alert the operator 11 of a threat. Further, this warning may advise the operator 11 of the presence of the objects 26a or 26b, and the level of risk associated with the objects 26a or 26b which lie within the areas of interest 25a, b and c as the overland vehicle 12 approaches the areas of interest 25a, b and c. Moreover, the danger assessment logic may provide both a visual and an audio alert to the operator 11 that the closing speed of the overland vehicle 12 is inappropriate relative to the objects 26a and 26b based upon the input provided regarding the outside temperature and humidity 107 and 108, or the traction input 109. These respective inputs may collectively indicate, for example, that icing of the underlying roadway has commenced and that the closing speed of the overland vehicle 12 and which is provided by speed sensor 102 is inappropriate. In addition, the digital or analog signal image output 71 may be manipulated or otherwise combined with iconic images or an animation having various colors provided by the image signal processor 80 in order to alert the observer or operator 11 of the relative hazards associated with the objects 26a or 26b which are located along or adjacent to the path of travel of the overland vehicle 12. For example, in one form of the invention, the image of one of the objects 26a, here depicted as a moose, may be processed and manipulated by the image signal processor 80 in order to provide a fanciful composite image of an animal, or some other geometric image, and not specifically that of the moose as seen in the drawings so as to enable the driver, at a glance, to quickly assess and understand the hazard condition(s) and level of threat to the safe operation of the overland vehicle 12. Still further, that same image might be colored differently in order to provide the operator with a readily discernible risk assessment. For example, the composite image which is formed of a plurality of image frames produced by the electroluminescent screen 54 of the image intensifier tube 50 may be colored yellow in order to show the operator 11 that they are still within safe braking distance from the object 26a. Further, a red or flashing image provided to the operator 11 may indicate that immediate evasive action or braking is required in order to avoid a collision with the object 26a and 26b. Moreover, as the overland vehicle 12 or the objects 26a and 26b traverse the respective depths of field, the image signal processor 80 continually provides useful feedback to the controller 43 in order to cause the controller to vary the timing, rate of pulsing, delay between pulses, or the relative output intensity of the emitter(s) 40, and the activating and deactivating of the shutter electrode or assembly 53 at any desired frequency or desired intervals in order to continually produce a visibly discernable image at the display 90. This is generally indicated by the line labeled 112 in FIG. 1.

In one possible form of the invention, the image signal processor 80 may be utilized for self calibration of the system on the start-up of the overland vehicle to ensure the proper operation of the object detection apparatus 10. Still further, based upon operator preferences, the present apparatus 10 and associated method may be calibrated at the factory, or by the operator to set the warning levels provided by the invention based upon driver habits; or the prevailing driving environment. For example, if an operator 11 principally does highway driving, the operator may prefer to set the invention 10 in a fashion whereby the closing ranges and speeds of adjacent vehicles are lengthened (or shortened) based upon the place where the driving takes place. Still further, the system could be calibrated to recognize certain shapes, such as vehicles, signs, pedestrians, live stock or the like.

Referring now to FIGS. 4-7A, the method for adjusting an object detection apparatus of the present invention 10 employs a number of different logics to implement certain features of the invention. Further, and as discussed above, some of these may be further employed for calibration and a diagnostic for the present invention 10. As should be understood, these logics as will be described are implemented by the controller 43 and/or image signal processor 80. Referring now to FIG. 4, and in one aspect of the present invention, the current method 10 includes, as a first step, providing an image intensifier tube 50 having a electroluminescent screen 54, and which produces a screen current (57, 58) associated with the electroluminescent screen 54 when the image intensifier tube 50 receives and processes electromagnetic radiation 42. Further, the method includes another step 120 of providing a shutter assembly or shutter electrode 53, having a function, and which is operably coupled to the image intensifier tube 50, and which, when activated 121, and then deactivated 122, causes the electroluminescent screen 54 of the image intensifier tube 50 to produce a light or optical output 61 which is converted into a first image frame 123 which can be discerned on the electroluminescent screen 54, and which has an associated screen current. The method includes another step 124 of providing an emitter of electromagnetic radiation 40 which is operably coupled to the controller 43, and which, when energized 125 and then deenergized, produces a pulse of electromagnetic radiation 41 which is directed towards an area of interest 25a, b, and c. Before the step of energizing the emitter 125, the method includes another step of measuring the screen current of the electroluminescent screen 54 when the emitter 40 is deenergized, and the shutter assembly 53 is in an activated position, to produce the first image frame 123. In some forms of the invention, this previously identified step may be repeated.

After the step of measuring the screen current without energizing the emitter 123, the method includes a step 125 of energizing the emitter 40 to direct electromagnetic radiation to the areas of interest 25a, b, or c. The method includes another step of waiting a predetermined period of time 126 after the energizing of the emitter 125, and then activating 127, and then deactivating the shutter assembly 128 at the end of the predetermined time after the energizing of the emitter 40 to capture electromagnetic radiation reflected from the areas of interest 25a, b and c, and to produce and record a second image frame 129 which has an associated screen current. The method includes another step 140 of comparing the screen currents associated with the first and second image frames to determine if the screen current associated with the second image frame 129 has a greater magnitude relative to the screen current associated with the first image frame 123. The method includes another step 141 of adjusting the duration of time that the emitter 40 is energized, and the shutter assembly 53 is activated, and then deactivated, based upon the comparison of the screen currents associated with the first and second image frames 140. As seen in FIG. 4, if the screen current associated with the second image frame 129 is not greater than that of the first image frame 123, the second image frame is retained 142 by the signaling processor 80, and the method then proceeds to again energize the light emitter 40, at step 125; wait a predetermined period of time thereafter at step 126; activate the shutter assembly 53 at step 127; record a second screen current associated with the second image frame at step 129; and deactivate the shutter assembly at step 128. Thereafter, the first and second image frames are compared and an adjustment is then made to the duration that the shutter assembly 53 is activated and/or the emitter 40 is energized in order to continually produce a visibly discernable image by the image intensifier tube 50. As should be understood, when the screen current associated with the first image frame is greater than the screen current associated with the second image frame, the method may further include an alternative step of repeating the steps of activating 121 and deactivating 122 the shutter assembly 53 without energizing the emitter 40 and then comparing the screen currents associated with the first 123, and second image frames 129 again. This is indicated by the line labeled 143. The comparison of the respective screen currents may be accomplished by the controller 43 and/or image signal processor 80 depending upon the form of the invention deployed on the overland vehicle 12.

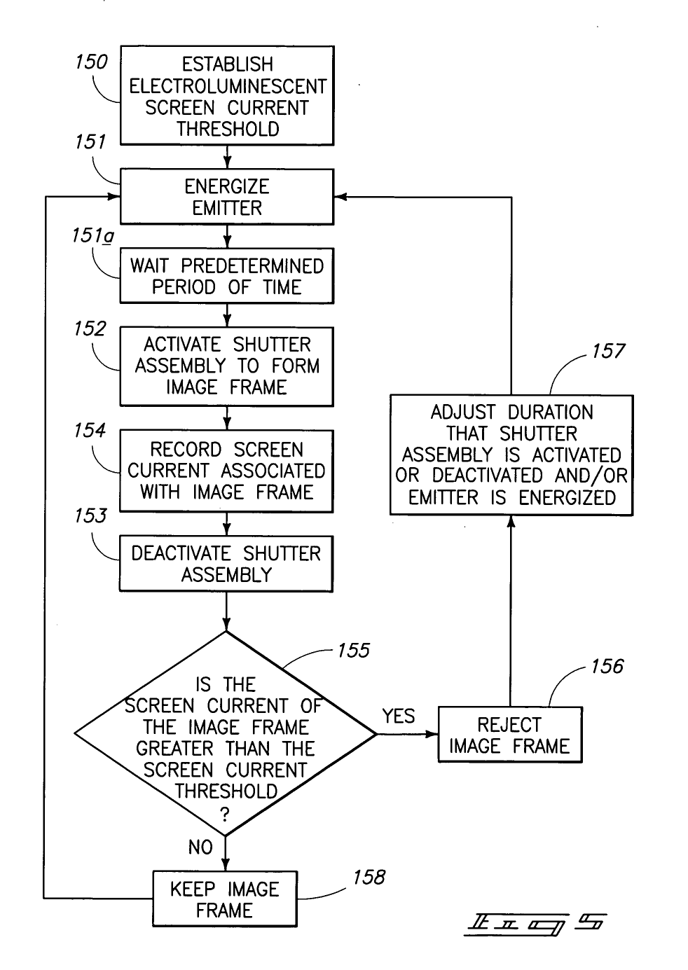

A method for adjusting an object detection apparatus 10 of the present invention includes the steps of providing an image intensifier tube 50 having an electroluminescent screen 54 which produces a screen current, and a light or optical output when the image intensifier tube processes a pulse of electromagnetic radiation 42 or other electromagnetic radiation produced by an object of interest 26. Such additional electromagnetic radiation may come from the headlights of an approaching vehicle or the like. The method includes another step of providing a shutter assembly 53 which is operably coupled to the image intensifier tube 50, and which, when placed in a first, activated condition, allows electromagnetic radiation 42 to be processed by the image intensifier tube 50, and a second, deactivated condition, which substantially prevents electromagnetic radiation from being processed by the image intensifier tube 50. The method includes another step of providing an emitter 40 which, when selectively energized, produces pulses of electromagnetic radiation 41 which are directed towards; and reflected 42 from an object of interest 26a and 26b and then received and processed by the image intensifier tube 50. The method includes another step of providing and positioning an imaging device 70 in light output receiving relation relative to the electroluminescent screen 54 of the image intensifier tube 50. Still further, the method includes another step of providing a controller 43 which is controllably coupled 56, 44 with each of the image intensifier tube 50; shutter assembly 53; and emitter 40, and wherein the controller 43 continually (or in some forms of the invention selectively) energizes the image intensifier tube 50, and selectively energizes the emitter 40, and shutter assembly 53 in a predetermined manner so as to cause the electroluminescent screen 54 to produce a light or optical output 61 which can be converted into an electrical image of the object of interest 26a and 26b, by the imaging device 70. The method includes another step of providing an image signal processor 80 which is operably coupled with each of the controller 43, and the imaging device 70, and which produces a composite electrical image output 81 representative of the objects of interest 26a, and b. The output 81 is converted into a perceivable image by means of the display 90. The method includes another step, as seen in FIG. 5, of determining or establishing a screen current threshold 150 produced by the image intensifier tube 50 when the image intensifier tube 50 is producing an undiscernable visual image of the object of interest 26a and b. The method includes another step 151 of selectively energizing the emitter 40, waiting a period of time 151(a), and activating 152, and deactivating 153, the shutter assembly 53 so as to produce multiple image frames each having an associated screen current 154. The method includes another step 155 of comparing the respective screen currents associated with the multiple image frames against the predetermined or established screen current threshold 150 to determine if the screen currents of the respective multiple image frames exceed the predetermined screen current threshold 150. If they do, the image frame(s) are rejected at step 156 by the controller 43 and/or image signal processor 80. After rejection of the image frame(s), the method includes another step 157 of adjusting the duration that the shutter assembly 53 is activated 152 and deactivated 153, and the emitter 40 is energized 151 so as to cause the image intensifier tube 50 to produce a light or optical output 61 which can be substantially continually converted into an electrical image of the objects of interest 26a and b, by the imaging device 70. In the methodology as described above, and when the screen current associated with the subsequent image frame is greater than the screen current threshold 150, the duration that the shutter assembly 53 is activated 152 is reduced and/or the emitter duration, intermittent delay, frequency, pattern and/or output intensity is reduced so as to produce a subsequent image frame having a screen current which is a fraction of the predetermined or established screen current threshold 150. In the methodology as described above, the duration that the shutter assembly 53 may be activated and then deactivated, or the emitter 40 duration, intermittent delay, frequency, pattern, and/or output intensity can be dynamically varied so as to produce a subsequent image frame having an associated screen current which may be greater than or equal to the previous image frame but as indicated above, still a fraction of the predetermined threshold. In addition to the foregoing, it should be understood that the method further includes the steps of predicting, in time, the relative movement of the object of interest 26a or 26b, within a given depth of field or the speed of same; and adjusting the duration that the shutter assembly 53 is activated and then deactivated based upon the predetermined movement or speed of the objects of interest 26a or 26b within the depth of field so as to ensure that a visibly discernable image continues to be produced by the display 90 as the object of interest traverses the given depth of field. In the present methodology, if the screen current of the subsequent image frame is less than the screen current threshold 150, the image frame is retained at 158, and the steps as seen in the flowchart of FIG. 5 are continually repeated to provide repeated image frames which are continuously displayed to the operator 11 by means of the visual display 90.

In the methodology as described above, an input device or sensor 100 is provided and which supplies information to the image signal processor 80 and/or controller 43. The input devices or sensors provide additional information which is helpful in fully considering the object of interest 26a and 26b as it moves within the area of interest 25a, b and c. The input devices are selected from a group comprising air temperature; vehicle speed or closing speed of the image intensifier tube 50 relative to the object of interest; time; overland speed of the vehicle or image intensifier tube; GPS coordinates of the overland vehicle or an approaching vehicle; the distance that the objects of interest 26a or 26b is located from the overland vehicle 12, or image intensifier tube 50; the size of the object of interest; the convergence of the vehicle or image intensifier tube with the object of interest 26a or 26b; recognition of the shape of the object of interest, and the type of electromagnetic radiation which is received (either visible or invisible), among many others.

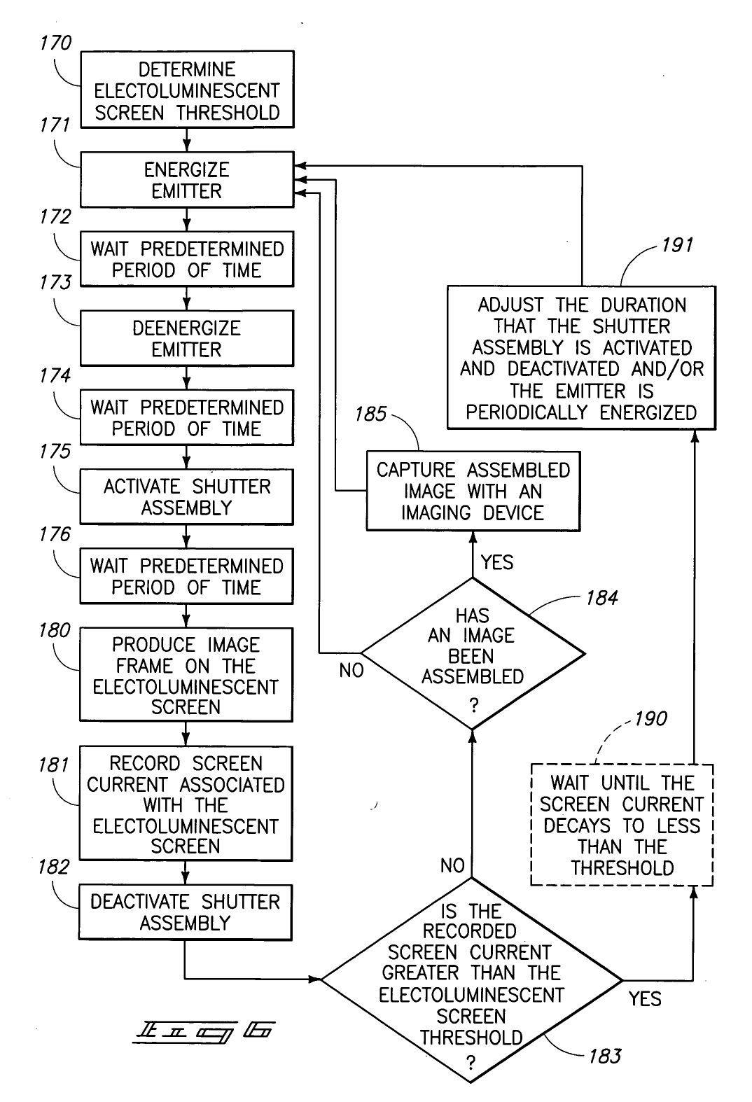

Referring now to FIG. 6 another logic that may be implemented in combination with the previously described logic, or by itself, is shown. As seen therein, the methodology 10 of the present invention includes a first step 170 of determining or establishing the electroluminescent screen 54 threshold. The methodology includes another step 171 of energizing the emitter 40 so as to generate electromagnetic radiation 41 which is directed to the objects of interest 26a and 26b, respectively. The methodology includes another step 172 of waiting a predetermined period of time, and step 173 includes deenergizing the emitter 40. Step 174 of the present invention relates to waiting a predetermined period of time following the deenergizing of the emitter 173. The method includes another step 175 of activating the shutter assembly 53, and a step 176 of waiting a predetermined period of time after activating the shutter assembly 53. The method includes another step 180 of producing an image frame on the electroluminescent screen 54, and a step 181 of recording the screen current associated with the electroluminescent screen. Still further, the method includes another step 182 of deactivating the shutter assembly 53. As seen in step 183, a determination is made regarding whether the recorded screen current as found in step 181 is greater than the electroluminescent screen threshold as determined at step 170. As seen in FIG. 6, if the screen current is not greater than the electroluminescent screen threshold, the logic then determines whether an image has been assembled at step 184 on the electroluminescent screen 54. While not shown herein, the image may, in some forms of the invention be assembled by the imaging device 70; and/or image signal processor 80. If the image has not been assembled, the methodology repeats steps 171-184. However, if an image has been assembled, the imaging-device 70 is operable at step 185 to capture the assembled image. Thereafter, the methodology includes repeating steps 171-185 as the overland vehicle 12 operates. As seen in FIG. 6, in the event that the recorded screen current is greater than the electroluminescent screen threshold at step 183, the method includes another optional step 190 of waiting until the screen current decays to less than the threshold screen current. The methodology includes a following step 191 where an adjustment of the duration that the shutter assembly 53 is activated and deactivated, and/or the emitter 40 is periodically energized so as to ensure the production of a visibly discernable image is then made. Thereafter, steps 171-191 are repeated so as to continually produce a visibly discernable image that is available to the operator of the overland vehicle 12 by means of display 90.

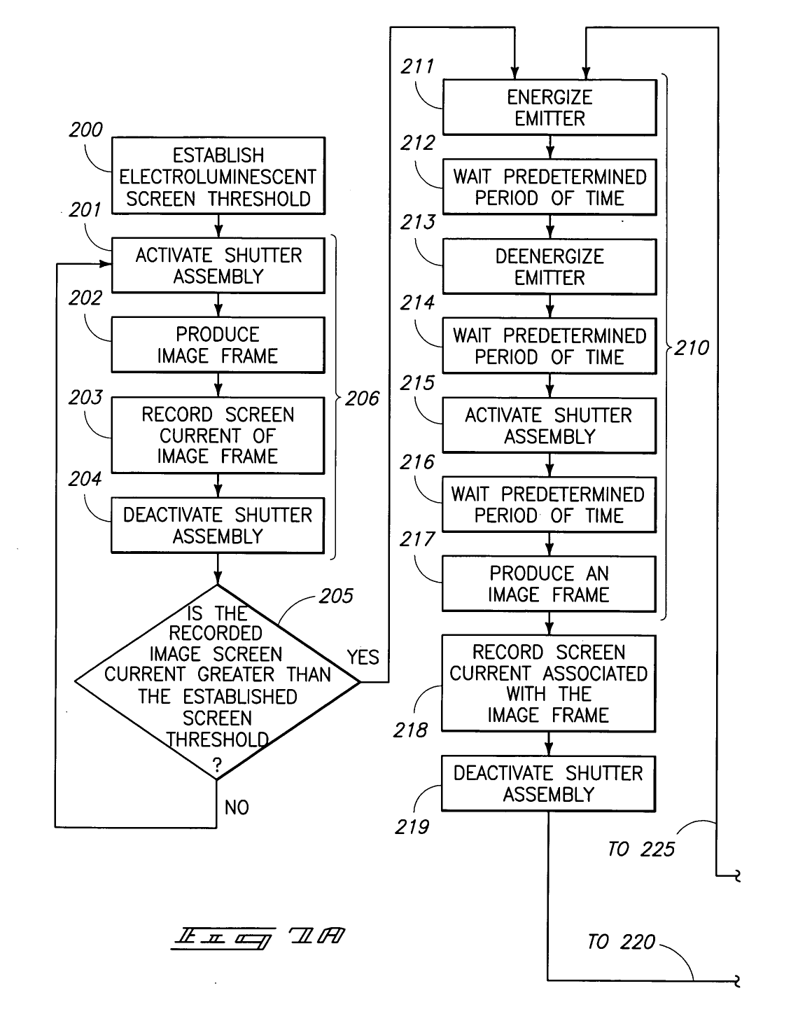

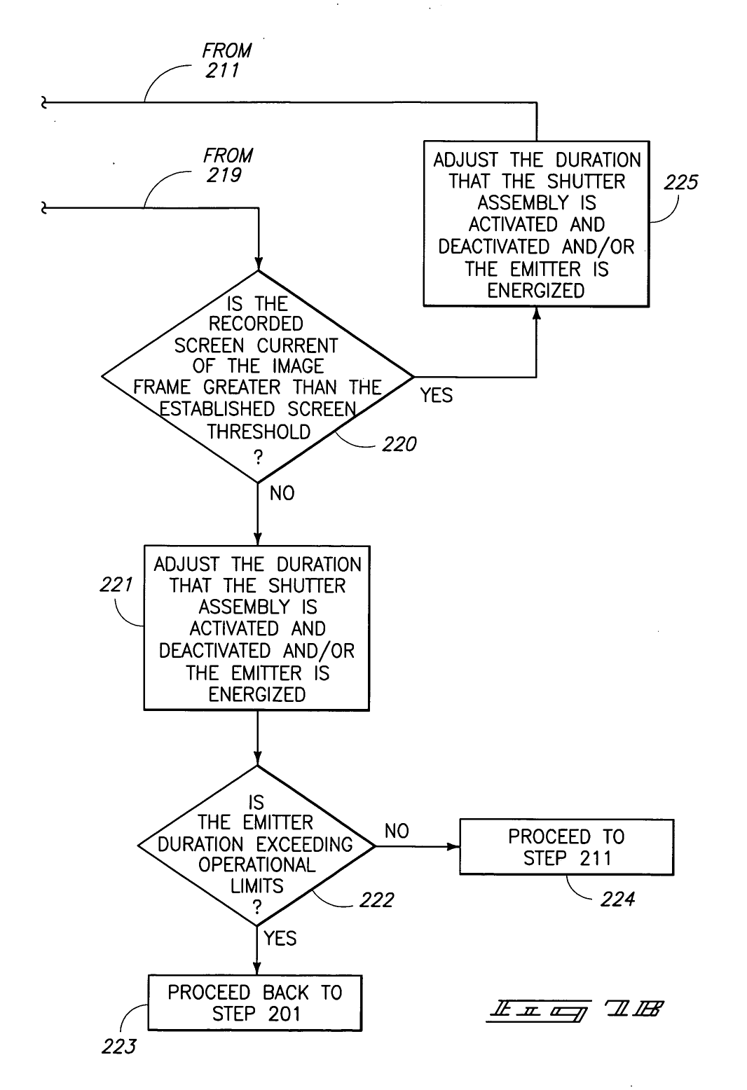

Referring now to FIGS. 7A and 7B, still another logic which may be implemented by the controller 43 and/or image signal processor 80 to provide additional features of the present methodology is illustrated. As should be understood, the logic as shown in FIG. 7A includes a first step 200 of determining or establishing the electroluminescent screen 54 threshold. The methodology includes another step 201 of activating the shutter assembly 53; and yet a further step 202 of producing an image frame following the activating of the shutter assembly 53. The method as seen in FIG. 7A includes yet another step 203 of recording the screen current of the image frame in step 202; and step 204 of deactivating the shutter assembly 53. The methodology includes a further step 205 which includes a determination regarding whether the recorded image screen current is greater than the established electroluminescent screen threshold. In the event that the image screen is not greater than the determined screen threshold, then the present methodology repeats steps 201-205. Steps 201-205 comprise an unsynchronized shutter mode of operation 206. In the event that the recorded image screen current at step 203 is greater than the determined screen threshold 200, the method continues to the plurality of steps which are indicated by the numeral 210 and which comprise a synchronized mode of operation. In this regard, the methodology of the present invention includes step 211 where the emitter 40 is energized; and step 212 where a predetermined time elapses following energizing. The method continues to step 213 where the emitter 40 is again deenergized. As seen, in step 214, the method includes waiting a predetermined period of time following deenergizing of the emitter 40. Still further, the methodology continues to step 215 which includes activating the shutter assembly; and step 216 of waiting a predetermined period of time after actuating the shutter assembly, the method includes another step 217 of producing an image frame; and step 218 of recording the screen current associated with the produced image frame. The method includes step 219 which relates to deactivating the shutter assembly. Following step 219, the methodology then makes a determination whether the recorded screen current associated with the image frame in step 218 is greater than the determined screen threshold at step 220 (FIG. 7B). If the recorded screen current is not greater than the determined screen threshold, then the methodology proceeds to step 221. As seen in FIG. 7B, step 221 relates to adjusting the duration that the shutter assembly is activated and then deactivated, and/or the emitter 40 is energized. The method of the invention continues at step 222 where a determination is made whether the emitter 40 is exceeding the operational limits of the object detection apparatus 10. If the determination is made by the logic that operational limits are being exceeded, the method proceeds at step 223 to go back to step 201 and repeat the aforementioned steps. On the other hand, in the event the logic determines that the emitter 40 is not exceeding the operational limits of the object detection apparatus 10, the method continues to step 224 and proceeds back to step 211 and repeats the steps following same. In the methodology as seen in FIG. 7B, if the logic determines at step 220 that the recorded screen current of the image frame is greater than the determined or established screen threshold 200, then the methodology proceeds to step 225 where an adjustment of the duration that the shutter assembly 53 is activated and deactivated and/or the emitter 40 is energized takes place. Following the aforementioned step of adjusting the duration that the shutter assembly 53 is activated and deactivated and/or the emitter is energized as seen in step 225, the methodology again returns to step 211 and repeats the steps following same in order to continually produce a visibly discernable image which may be provided to the operator of the overland vehicle 12 by means of the display 90.

### Operation

The operation of the described embodiment of the present invention is believed to be readily apparent and is briefly summarized at this point.

A method for adjusting an object detection apparatus 10 of the present invention broadly includes the steps of providing an image intensifier tube 50 having an electroluminescent screen 54, and which produces a light or optical output 61, and a screen current associated with the light or optical output when the image intensifier tube processes electromagnetic radiation. The method includes yet another step of providing an emitter 40 which, when selectively energized, produces pulses of electromagnetic radiation 41 which are directed at, and reflected 42 from an object of interest 26a or b. Still further, the method includes another step of providing a shutter assembly 53 which is operably coupled to the image intensifier tube 50, and which when selectively activated and deactivated permits the image intensifier tube 50 to receive, and then process the pulses of electromagnetic radiation 42 which are reflected from the objects of interest 26a or b. The method includes another step of providing a controller 43 which is operably coupled to the image intensifier tube 50, emitter 40; and shutter assembly 53 and which continually energizes the image intensifier tube 50; and controllably energizes the emitter 40; and shutter assembly 53. The method includes another step of providing an imaging device 70 which is located adjacent to the electroluminescent screen 54, and which receives the light or optical output 61 of the electroluminescent screen 54 and which converts the light or optical output 61 into a visibly discernable electrical image of the objects of interest 26a and 26b. The method includes another step of determining a screen current threshold 170 produced by the electroluminescent screen 54, and which is associated with the production of an undiscernable image by the imaging device 70 and the display 90. The method includes another step 171 of energizing the emitter 40, and thereafter activating 175 and deactivating 182 the shutter assembly 53, and then measuring the screen current at step 171 which is produced by electroluminescent screen. The method includes another step 183 of comparing the screen currents to the predetermined screen current threshold 170. The method includes another step 191 of adjusting the duration of time that the emitter of light 40 is energized, and the shutter assembly 53 is activated and deactivated based upon the comparison of the respective screen currents; and periodically repeating the steps 171-191 so that a visually discernable image of the object of interest 26a, b is produced by the imaging device 70, and displayed to the operator by means of display 90 as the object of interest traverses the areas of interests 25a, b and c, respectively.

Therefore, it will be seen that the present methodology provides numerous advantages over the prior art techniques and teachings including substantially minimizing any “bloom effect” which may result from any reflected or other direct light sources which may be located within an area of interest which is being viewed by the observer. Still further, the simplicity of construction of the present device renders the present device useful for many civilian and other industrial applications.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

We claim:

1. A method for adjusting an object detection apparatus, comprising:
providing an image intensifier tube having a electroluminescent screen, and which produces a screen current output when the image intensifier tube processes electromagnetic radiation;
measuring the screen current output produced by the electroluminescent screen;
providing an emitter of electromagnetic radiation which is electrically coupled with a source of electricity, and which, when periodically energized, produces an electromagnetic radiation output; and
adjusting the period of time which the emitter of electromagnetic radiation is energized based upon the screen current output which is measured at the electroluminescent screen.

2. A method as claimed in claim 1, and further comprising:
providing a shutter assembly which is operably coupled to the image intensifier tube, and which, when activated and deactivated, causes the image intensifier tube to produce an image frame which is associated with the screen current output.

3. A method as claimed in claim 2, and wherein the shutter assembly when deactivated, at least partially, prevents the processing of electromagnetic radiation.

4. A method as claimed in claim 1, and further comprising:
providing a shutter assembly operably coupled to the image intensifier tube, and which can be activated and deactivated; and
providing a controller which is operably coupled to the image intensifier tube, emitter of electromagnetic radiation, and shutter assembly, and which continually energizes the image intensifier tube, and further selectively activates and deactivates the shutter assembly, and further energizes the emitter of electromagnetic radiation so as to produce a resulting light output generated from the electroluminescent screen which can be converted into a visibly discernible image.

5. A method as claimed in claim 1, and further comprising:
providing a controller which is operably coupled with the image intensifier tube and with the emitter of electromagnetic radiation;
selectively energizing the emitter of electromagnetic radiation to produce electromagnetic radiation pulses which are reflected from the object of interest; and
providing a shutter assembly which may be activated and deactivated.

6. A method as claimed in claim 5, and further comprising:
adjusting a time period delay between the selective energizing of the emitter of electromagnetic radiation, and the selective activating and deactivating of the shutter assembly.

7. A method as claimed in claim 5, and wherein the method further comprises:
selectively controlling the emitter of electromagnetic radiation to produce electromagnetic radiation which is reflected from the object of interest; and
selectively activating and deactivating the shutter assembly so as to cause the electroluminescent screen to produce a visibly discernible image.

8. A method as claimed in claim 7, and wherein the object of interest is traversing a given depth of field relative to the emitter of electromagnetic radiation, and wherein the method further comprises:
selectively adjusting the duration that the shutter assembly is activated and then deactivated as the object of interest traverses the depth of field so as to continually produce a visibly discernible image.

9. A method as claimed in claim 7, and wherein the step of selectively energizing the emitter of electromagnetic radiation further comprises adjusting a frequency with which the emitter of electromagnetic radiation is energized.

10. A method as claimed in claim 7, and wherein the step of selectively energizing the emitter of electromagnetic radiation further comprises adjusting a duration that the emitter of electromagnetic radiation is energized.

11. A method as claimed in claim 7, and wherein the step of selectively energizing the emitter of electromagnetic radiation further comprises adjusting an output intensity of the emitter of electromagnetic radiation when energized.

12. A method as claimed in claim 8, and further comprising:
before the step of selectively adjusting the duration that the shutter assembly is activated, and then deactivated, predicting, in time, the relative movement of the object of interest within the depth of field.

13. A method as claimed in claim 4, and further comprising:
providing a shutter assembly which is operably coupled to the controller and which is selectively activated and then deactivated so as to cause the electroluminescent screen to produce an image frame, and wherein the method further comprises:
measuring a screen current associated with a first image frame which is produced by the electroluminescent screen when the shutter assembly is activated, and then deactivated, and when the emitter of electromagnetic radiation is deenergized;
measuring a screen current associated with a second image frame which is provided by the electroluminescent screen when the shutter assembly is activated, and then deactivated, following the energizing of the emitter of electromagnetic radiation;
comparing the screen currents associated with the first and second image frames; and
adjusting the duration of time that the emitter of electromagnetic radiation is energized, and the shutter assembly is activated, and then deactivated, based upon a comparison of the screen currents associated with the first and second image frames so as to cause the electroluminescent screen to produce a resulting visibly discernible image.

14. A method as claimed in claim 13, and further comprising:
predicting, in time, the relative movement of the object of interest across a given depth of field;
selectively adjusting the duration that the shutter assembly is activated, and then deactivated, as the object of interest traverses the depth of field so as to continually produce a visibly discernible image.

15. A method as claimed in claim 14, and wherein the step of selectively energizing the emitter of electromagnetic radiation comprises adjusting a frequency, duration, pattern, and/or output intensity of the emitter of electromagnetic radiation when energized.

16. A method as claimed in claim 14, and further comprising:
predicting in time the relative movement of the object of interest across the depth of field and adjusting a time period delay between the energizing of the electromagnetic radiation emitter.

17. A method for adjusting an object detection apparatus comprising:
providing an image intensifier tube having an electroluminescent screen and which produces a screen current when the image intensifier tube processes electromagnetic radiation;
providing a shutter assembly operably coupled to the image intensifier tube and which, when activated, and then deactivated, causes the electroluminescent screen to produce a light output which is converted into an image frame having an associated screen current;
providing an emitter of electromagnetic radiation which is operably coupled to the image intensifier tube, and the shutter assembly, and which, when energized, produces electromagnetic radiation which is directed towards an area of interest; and
measuring the screen current associated with a first image frame when the emitter of electromagnetic radiation is deenergized, and the shutter assembly is activated.

18. A method for adjusting an object detection apparatus comprising:
providing an image intensifier tube having a photoanode, a photocathode, a microchannel plate, and an electroluminescent screen, and which produces a screen current when the image intensifier tube processes electromagnetic radiation;
providing a shutter assembly operably coupled to the image intensifier tube and which, when activated, and then deactivated, causes the electroluminescent screen to produce a light output which comprises an image frame having an associated screen current;
recording the electroluminescent screen current; and
adjusting the voltage potential between the microchannel plate and the photoanode based upon the recorded electroluminescent screen current.

19. A method for adjusting an object detection apparatus, comprising:
providing an image intensifier tube having a photoanode, a photocathode, a microchannel plate, and an electroluminescent screen, and which produces a screen current output when the image intensifier tube processes electromagnetic radiation;
activating the image intensifier tube by switching the voltage between the microchannel plate and the photocathode on and off;
measuring the screen current output produced by the electroluminescent screen when the image intensifier tube is switched on and off; and
adjusting the period of time which the image intensifier tube is energized based upon the screen current output which is measured at the electroluminescent screen.

20. A method for adjusting an object detection apparatus, comprising:
providing an image intensifier tube having an electroluminescent screen, and which produces a screen current output when the image intensifier tube processes electromagnetic radiation;
measuring the screen current output produced by the electroluminescent screen;
providing an emitter of electromagnetic radiation which is electrically coupled with a source of electricity, and which, when periodically energized, produces an electromagnetic radiation output; and
adjusting the intensity of the electromagnetic radiation output of the emitter of electromagnetic radiation based, at least in part, upon the screen current output which is measured at the electroluminescent screen.

21. A method for adjusting an object detection apparatus comprising:
providing an image intensifier tube having an electroluminescent screen and which produces a screen current when the image intensifier tube processes electromagnetic radiation;
providing a shutter assembly operably coupled to the image intensifier tube and which, when activated, and then deactivated, causes the electroluminescent screen to produce a light output which comprises an image frame having an associated screen current;
providing an emitter of electromagnetic radiation which is operably coupled to the image intensifier tube, and the shutter assembly, and which, when energized, produces electromagnetic radiation which is directed towards an area of interest;
measuring the screen current associated with a first image frame when the emitter of electromagnetic radiation is deenergized, and the shutter assembly is activated;
after the step of measuring the screen current associated with a first image frame, energizing the emitter of electromagnetic radiation to direct electromagnetic radiation to the area of interest;
timing the energizing of the emitter of electromagnetic radiation;
activating and deactivating the shutter assembly at a predetermined time after the energizing of the emitter of electromagnetic radiation to capture the electromagnetic radiation reflected from the area of interest, and to produce a second image frame which is associated with a second screen current;
comparing the screen currents associated with the first and second image frames to determine if the screen current associated with the second image frame has a greater magnitude relative to the screen current associated with the first image frame; and
adjusting the duration of time that the emitter of electromagnetic radiation is energized, and the shutter assembly is activated, and then deactivated based upon the comparison of the screen currents associated with the first and second image frames.

22. A method as claimed in claim 21, and wherein when the screen current associated with the second image frame is greater than the screen current associated with the first image frame, the method further comprises:
repeating the steps of activating and deactivating the shutter assembly without energizing the emitter of electromagnetic radiation and then comparing the screen currents associated with the first and second image frames again.

23. A method as claimed in claim 21, and wherein the image intensifier tube produces a visibly discernable image on the electroluminescent screen when the image intensifier tube processes electromagnetic radiation, and wherein the image intensifier tube, when processing excessive amounts of electromagnetic radiation, produces an undiscernable visible image on the electroluminescent screen, and wherein a predetermined threshold amount of screen current is associated with the production of the undiscernable image on the electroluminescent screen, and wherein the method further comprises:
comparing the screen current associated with the second image frame with the predetermined threshold of the screen current associated with the undiscernible image to determine if the screen current associated with the second image frame exceeds the predetermined threshold; and
decreasing the duration that the shutter assembly is activated and then deactivated so as to produce a discernable image on the electroluminescent screen.

24. A method as claimed in claim 23, and wherein the duration that the shutter assembly is activated and then deactivated is reduced so as to produce a subsequent second image frame having a screen current which is a fraction of the predetermined threshold.

25. A method as claimed in claim 23, and wherein the duration that the shutter assembly is activated can be varied so as to produce a second image frame having a screen current which is greater than or equal to the first image frame, but a fraction of the predetermined threshold.

26. A method as claimed in claim 21, and further comprising:
determining the speed of an object within the area of interest and relative to the image intensifier tube based upon the screen current associated with the second image frame.

27. A method as claimed in claim 21, and wherein the electromagnetic radiation reflects from an object traversing a given depth of field relative to the image intensifier tube, and wherein the method further comprises:
predicting, in time, the relative movement of the object of interest within the depth of field; and
adjusting the duration that the shutter assembly is activated based, at least in part, upon the predicted relative movement of the object of interest within the depth of field so as to ensure that a visibly discernable image continues to be produced by the electroluminescent screen as the object of interest traverses the depth of field.

28. A method for adjusting an object detection apparatus, comprising:
providing an image intensifier tube having an electroluminescent screen and which produces a screen current and a light output when the image intensifier tube processes electromagnetic radiation;
providing a shutter assembly which is operably coupled to the image intensifier tube and which, when selectively energized, can be placed in a first, activated condition which allows light to be processed by the image intensifier tube, and a second, deactivated condition, which substantially prevents light from being processed by the image intensifier tube;
providing an emitter of electromagnetic radiation which, when selectively energized, produces pulses of electromagnetic radiation which are directed towards, and reflected from, an object of interest, and which are then received and selectively processed by the image intensifier tube;
providing and positioning an imaging device in light output receiving relation relative to the electroluminescent screen;
providing a controller which is controllably coupled with each of the image intensifier tube, shutter assembly and emitter of electromagnetic radiation, and wherein the controller continually energizes the image intensifier tube, selectively energizes the emitter of electromagnetic radiation, and further activates and deactivates the shutter assembly in a predetermined manner so as to cause the electroluminescent screen to produce a light output which can be converted into an electronic image of the object of interest by the imaging device;
providing an image signal processor which is operably coupled with each of the controller, and the imaging device, and wherein the image signal processor receives the electronic image produced by the imaging device, and produces a visibly discernible composite image output representative of the object of interest;
determining a screen current threshold produced by the electroluminescent screen when the electroluminescent screen is producing an undiscernable image of the object of interest;
selectively energizing the emitter of electromagnetic radiation, continually energizing the image intensifier tube, and activating and deactivating the shutter assembly so as to cause the electroluminescent screen to produce multiple image frames each having an associated screen current;
comparing the respective screen currents of the multiple image frames against the screen current threshold to determine if the screen currents associated with the respective multiple image frames exceed the screen current threshold; and
adjusting the duration that the shutter assembly is activated and then deactivated, so as to cause the electroluminescent screen to produce a light output which can be substantially continually converted into an electronic image of the object of interest by the imaging device.

29. A method as claimed in claim 28, and further comprising:
before the step of decreasing the duration that shutter assembly is activated and then deactivated, predicting, in time, the relative movement of the object of interest within a given depth of field.

30. A method as claimed in claim 28, and wherein the duration that the shutter assembly is activated and then deactivated is reduced so as to produce a subsequent image frame having a screen current which is a fraction of the predetermined screen current threshold.

31. A method as claimed in claim 28, and further comprising:
measuring the screen current provided by the electroluminescent screen when the emitter of electromagnetic radiation is deenergized and the shutter assembly is activated and then deactivated to produce a first image frame;
after the step of measuring the screen current without energizing the emitter of electromagnetic radiation, energizing the emitter of electromagnetic radiation to direct a pulse of electromagnetic radiation at the object of interest;
timing the energizing of the emitter of electromagnetic radiation; and
activating and deactivating the shutter assembly at a predetermined time after the energizing of the emitter of electromagnetic radiation so as to capture electromagnetic radiation which is reflected from the object of interest and to produce a second image frame having an associated second screen current.

32. A method as claimed in claim 31, and wherein the step of comparing the screen currents of the multiple image frames against the determined screen current threshold, further comprises:
comparing the screen currents of the first and second image frames to determine if the screen current associated with the second image frame is of a greater magnitude than the screen current associated with the first image frame; and
adjusting the duration that the emitter of electromagnetic radiation is energized, and the shutter assembly is activated and then deactivated, based upon the comparison of the screen currents associated with the first and second image frames.

33. A method as claimed in claim 28, and further comprising:
providing an input device coupled in signal transmitting relation relative to the image signal processor and which provides additional information which is useful in fully considering the object of interest.

34. A method as claimed in claim 33, and wherein the input device provides information to the image signal processor, and which is selected from the group comprising outside air temperature; closing speed of the image intensifier tube relative to the object of interest; time; overland speed of the image intensifier tube; GPS coordinates; the type of electromagnetic radiation received by the image intensifier tube; the distance that the object of interest is located from the image intensifier tube; the size of the object of interest; the convergence of the image intensifier tube with the object of interest, and the recognized shape of the object of interest, and the wavelengths of electromagnetic radiation which are being processed.

35. A method for adjusting an object detection apparatus, comprising:
a. providing an image intensifier tube having an electroluminescent screen, and which processes electromagnetic radiation so as to produce a light output from the electroluminescent screen, and a screen current associated with the light output;
b. providing an emitter of electromagnetic radiation which, when selectively energized, produces pulses of electromagnetic radiation which are directed at, and reflected from an object of interest;
c. providing a shutter assembly which is operably coupled to the image intensifier tube, and which when selectively activated and deactivated permits the image intensifier tube to receive and then process the pulses of electromagnetic radiation which are reflected from the object of interest and other electromagnetic radiation which is generated by the object of interest;
d. providing a controller which is operably coupled to the image intensifier tube, emitter of electromagnetic radiation and shutter assembly and which continually energizes the image intensifier tube, selectively energizes the emitter of electromagnetic radiation, and further activates and deactivates the shutter assembly;
e. providing an imaging device which is located adjacent to the electroluminescent screen, and which receives the light output of the electroluminescent screen and which converts the light output into an electronic image of the object of interest;
f. determining a threshold screen current produced by the electroluminescent screen and which is associated with the production of an undiscernable electronic image by the imaging device;
g. energizing the image intensifier tube and activating and deactivating the shutter assembly, and then measuring a first screen current produced by the electroluminescent screen;
h. after step g, energizing the image intensifier tube, and the emitter of electromagnetic radiation which produces a pulse of electromagnetic radiation which is directed to, and reflected from, the object of interest, and then activating and deactivating the shutter assembly at a predetermined time, and measuring a second screen current produced by the electroluminescent screen;
i. comparing the first and second screen currents to each other, and to the predetermined threshold screen current;
j. adjusting the duration of time that the emitter of electromagnetic radiation is energized, and the shutter assembly is activated and deactivated based upon the comparison of the respective screen currents; and
k. periodically repeating steps g-j so that a visually discernable electronic image of the object of interest is produced by the imaging device.
